(19) United States
(12) Patent Application Publication
(10) Pub. No.: US 2021/0035039 A1
(43) Pub. Date: Feb. 4, 2021

(54) SERVER, INFORMATION PROCESSING SYSTEM, AND INFORMATION PROCESSING METHOD

(71) Applicants: TOYOTA JIDOSHA KABUSHIKI KAISHA, Toyota-shi (JP); DENSO CORPORATION, Kariya-city (JP)

(72) Inventors: Yukari SUZUKI, Setagaya-ku (JP); Naoki YAMADA, Toyota-shi (JP); Toshihiro ARAI, Nagoya-shi (JP); Kuniaki JINNAI, Nagoya-shi (JP); Keiichi UNO, Chita-gun (JP)

(73) Assignees: TOYOTA JIDOSHA KABUSHIKI KAISHA, Toyota-shi (JP); DENSO CORPORATION, Kariya-city (JP)

(21) Appl. No.: 16/943,081

(22) Filed: Jul. 30, 2020

(30) Foreign Application Priority Data
Jul. 30, 2019 (JP) 2019-140198

(51) Int. Cl. G06Q 10/06; G06Q 10/08; B60W 60/00; H04W 4/021; H04W 4/40

(52) U.S. Cl. CPC G06Q 10/06311; G06Q 10/0832; H04W 4/40; B60W 60/00256; H04W 4/021; G06Q 10/08355

(57) ABSTRACT

Food and drink are served to a greater number of users by a vehicle that is requested by the users and in which food and drink can be prepared and served. A server according to the present disclosure includes a communication interface for acquiring a dispatch request from a terminal apparatus, the dispatch request including at least information regarding a vehicle, dispatch of which is requested by a user and in which food and drink can be prepared and served, and a controller for determining a vehicle dispatch schedule for the vehicle according to the dispatch request acquired by the communication interface.

### CROSS-REFERENCE TO RELATED APPLICATION

The present application claims priority to Japanese Patent Application No. 2019-140198 filed on Jul. 30, 2019, the entire contents of which are incorporated herein by reference.

### TECHNICAL FIELD

The present disclosure relates to a server, an information processing system, and an information processing method.

### BACKGROUND

As an example, JP 2016-212906 A (PTL 1) discloses a technology for acquiring data indicating user actions related to a plurality of websites associated with a shop or a facility (such as the number of times the website are viewed, the time spent thereon, the number of registered bookmarks, and the like), and for calculating a degree of interest of the user in the shop or the facility on the basis of the acquired data.

### CITATION LIST

### Patent Literature

PTL 1: JP 2016-212906 A

### SUMMARY

In recent years, serving of food and drink to customers using a vehicle in which food and drink can be prepared and served (a so-called food truck or kitchen car) has become commonplace. Normally, a food truck operates at a certain date and time and at a certain location that are determined in advance. Accordingly, for example, it is difficult for users to be served with food and drink by a food truck at a location that is not close to the certain location where the food truck is operating. That is, there is a problem in that food and drink cannot be served by a food truck of one's choice to many users who wish to be served with food and drink by the food truck.

The technology described in PTL 1 is a technology for calculating the degree of interest of a user in a shop or a facility, and does not give sufficient consideration to the problem described above.

An object of the present disclosure made in view of the problem as described above is to provide a server, an information processing system, and an information processing method by which food and drink can be served to a greater number of users by a vehicle in which food and drink can be prepared and served in accordance with requests from the users.

A server according to an embodiment of the present disclosure is a server capable of communicating with at least one terminal apparatus that is used by a user, the server including:

an acquisition interface for acquiring a dispatch request from the terminal apparatus, the dispatch request including at least information regarding a vehicle in which food and drink can be prepared and served and dispatch of which is requested by the user; and

a controller for determining a vehicle dispatch schedule for the vehicle according to the dispatch request acquired by the acquisition interface.

An information processing system according to an embodiment of the present disclosure includes:

at least one terminal apparatus that is used by a user; and

a server that is capable of communicating with the terminal apparatus, where

the terminal apparatus transmits, in response to an input from the user, a dispatch request which includes at least information about a vehicle in which food and drink can be prepared and served, and dispatch of which is requested by the user, and

the server
acquires the dispatch request from the terminal apparatus, and
determines a vehicle dispatch schedule for the vehicle according to the dispatch request that is acquired.

An information processing method according to an embodiment of the present disclosure is an information processing method for a server that is capable of communicating with at least one terminal apparatus that is used by a user, the method including:

acquiring a dispatch request from the terminal apparatus, the dispatch request including at least information regarding a vehicle in which food and drink can be prepared and served, and dispatch of which is requested by the user; and

determining a vehicle dispatch schedule for the vehicle according to the dispatch request that is acquired.

According to embodiments of the present disclosure, food and drink can be served to a greater number of users by a vehicle in which food and drink can be prepared and served, in accordance with requests from the users.

### BRIEF DESCRIPTION OF THE DRAWINGS

In the accompanying drawings:

FIG. 1 is a diagram illustrating an example configuration of an information processing system according to an embodiment of the present disclosure;

FIG. 2 is a diagram illustrating an example configuration of a server illustrated in FIG. 1;

FIG. 3 is a diagram illustrating an example of information that is stored in a memory illustrated in FIG. 2;

FIG. 4 is a flowchart illustrating example operation of a terminal apparatus illustrated in FIG. 1; and

FIG. 5 is a flowchart illustrating example operation of the server illustrated in FIG. 1.

### DETAILED DESCRIPTION

Hereinafter, an embodiment of the present disclosure will be described with reference to the drawings. In the drawings, the same reference signs are used to indicate same or equivalent constituent elements.

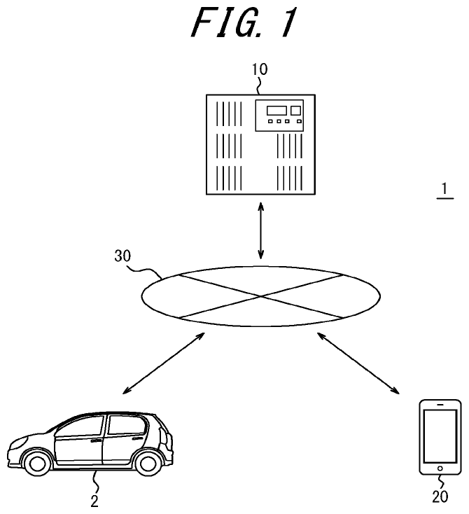

FIG. 1 is a diagram illustrating an example configuration of an information processing system 1 according to an embodiment of the present disclosure. The information processing system 1 according to the present embodiment includes a server 10 and a terminal apparatus 20. The server 10 and the terminal apparatus 20 are communicably connected to a network 30, which may encompass a mobile communication network, the Internet and the like, for example. The server 10 includes one or a plurality of server devices. For example, the terminal apparatus 20 may be, but is not limited to, a smartphone, a smart speaker, a personal computer (PC) or the like, and may be any apparatus that is used by a user.

First, an outline of the present embodiment will be described, with details given later. In response to an input from a user, the terminal apparatus 20 transmits a dispatch request which includes at least information regarding a vehicle 2 (a so-called food truck or kitchen car) in which food and drink can be prepared and served, the dispatch of which is requested by the user. The server 10 acquires the dispatch request from the terminal apparatus 20, and determines a vehicle dispatch schedule for the vehicle 2 according to the dispatch request that is acquired.

According to this configuration, a vehicle dispatch schedule for the vehicle 2, dispatch of which is requested by a user, is determined according to an input, by the user, to the terminal apparatus 20, that is related to the vehicle 2 in which food and drink can be prepared and served, and dispatch of which is requested. Accordingly, food and drink can be served by the vehicle 2 as requested by a user, even with respect to a user who is at a location where the vehicle 2 does not normally operate. Accordingly, food and drink can be served to a greater number of users by a vehicle 2 in which food and drink can be prepared and served, in accordance with requests from the users.

Next, each component of the information processing system 1 will be described in detail.

The vehicle 2 is a vehicle in which food and drink can be prepared and served (a so-called food truck or kitchen car). For example, the vehicle 2 operates at a certain date and time, and at a certain location that are determined in advance.

The vehicle 2 may include an autonomous driving function for automatically performing vehicle control on the basis of control information from an external source. In the present embodiment, “autonomous driving” includes automation of some or all of the user operations for driving a vehicle. For example, autonomous driving may encompass levels 1 to 5 defined by the Society of Automotive Engineers (SAE). Furthermore, the vehicle 2 may include a data communication module, for example, and may be connected to the network 30 by the data communication module in the manner illustrated in FIG. 1. At least a part of an application programming interface (API) defining the specifications for control information is disclosed to a service provider that provides services using vehicles which include the autonomous driving function. The service provider can freely program autonomous driving control software using the disclosed API. Accordingly, the service provider may provide any mobility service (such as a dispatch service for the vehicle 2 according to the present embodiment) by installing facilities, in accordance with a given purpose, in a cabin space of the vehicle which includes the autonomous driving function, and by programming autonomous driving control software using the API in accordance with the given purpose. In a case in which the vehicle 2 includes the autonomous driving function, the vehicle 2 may receive the vehicle dispatch schedule determined by the server 10, and perform autonomous driving on the basis of the received vehicle dispatch schedule.

As described above, the terminal apparatus 20 transmits a dispatch request for the vehicle 2 to the server 10, in response to an input from a user. Moreover, the terminal apparatus 20 may have any configuration as long as a function for performing communication via the network 30, a function for receiving an input from a user, a function for displaying various pieces of information, and the like, are included. The configuration of the terminal apparatus 20 having such functions is well known, and a description thereof is therefore omitted.

Next, a configuration of the server 10 will be described.

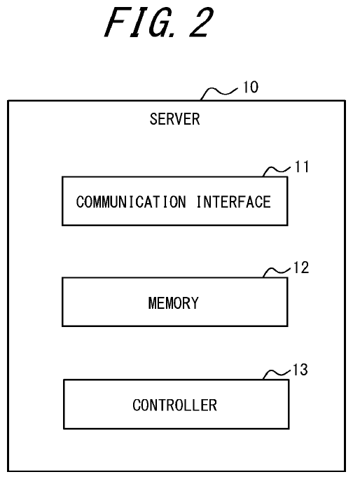

FIG. 2 is a diagram illustrating an example configuration of the server 10 according to the present embodiment.

The server 10 illustrated in FIG. 2 includes a communication interface 11, a memory 12, and a controller 13. The communication interface 11 is an example of an acquisition interface.

The communication interface 11 includes one or more communication modules that are connected to the network 30. For example, the communication module is compatible with mobile communication standards such as the 4th Generation (4G) and 5th Generation (5G) standards, wired local area network (LAN) standards or wireless LAN standards, but the communication module may be compatible with any communication standards without being limited to the above. In the present embodiment, the server 10 is connected to the network 30 via the communication interface 11. The communication interface 11 receives (acquires) a dispatch request for the vehicle 2 that is transmitted from the terminal apparatus 20 via the network 30. Additionally, FIG. 1 illustrates only one terminal apparatus 20, but the present disclosure is not limited to such a case. The communication interface 11 may acquire dispatch requests from a plurality of terminal apparatuses 20. Furthermore, the dispatch request from the terminal apparatus 20 may be stored by other servers that are connected to the network 30, instead of the server 10, for example. In this case, the communication interface 11 accesses, via the network 30, a server storing the dispatch request, and acquires the stored dispatch request.

For example, the memory 12 may be, but is not limited to, a main memory, an auxiliary memory, or a cache memory. The memory 12 stores any piece of information that is used in operation of the server 10. For example, the memory 12 may store a system program, an application program, a database, and the like. Information that is stored in the memory 12 may be updated by information that is acquired from the network 30 via the communication interface 11, for example.

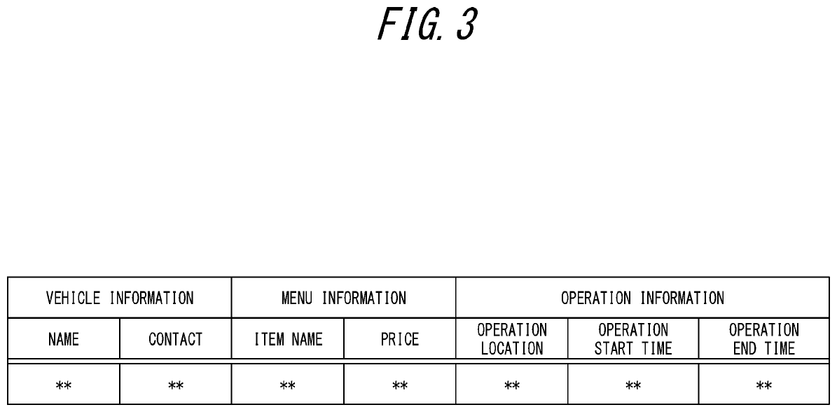

An example of information that is stored in the database in the memory 12 will be described with reference to FIG. 3. In the present embodiment, vehicle information, menu information, and operation information are stored in the database in association with one another.

The vehicle information includes any information about the vehicle 2 that is a target for determination of the vehicle dispatch schedule by the information processing system 1 according to the present embodiment. For example, the vehicle information includes the name of the vehicle 2 and contact information (such as a telephone number or an email address) of an operator of the vehicle 2. Furthermore, in a case in which the vehicle 2 itself may be connected to the network 30 in the manner illustrated in FIG. 1, the vehicle information may include an address for communication via the network 30 that is assigned to the vehicle 2.

The menu information includes arbitrary information related to menu items that are served by the vehicle 2 corresponding to the vehicle information. For example, the menu information includes information such as item names and prices of foods and drinks that are served by the vehicle 2. The menu information may also include photos of foods and drinks that are served by the vehicle 2.

The operation information includes any information related to operation of the vehicle 2 corresponding to the vehicle information. For example, the operation information includes information such as an operation location where the vehicle 2 operates, an operation start time that is a time when operation at the operation location starts, and an operation end time that is a time when operation at the operation location ends.

For example, the vehicle information, the menu information, and the operation information are input by the operator of the vehicle 2 who wants the information processing system 1 to determine the vehicle dispatch schedule.

Additionally, expected use location information may be stored in the database in the memory 12, the expected use location information being about a location (such as a workplace or a home) that is registered in advance by the user of the terminal apparatus 20 and that is a location where use of the vehicle 2 (food truck) by the user is expected, for example.

Referring back to FIG. 2, the controller 13 includes one or more processors. In the present embodiment, the “processor” is, but not limited to, a general-purpose processor or a dedicated processor dedicated to specific processing. The controller 13 controls operation of the entire server 10. Details of the operation of the server 10 that is controlled by the controller 13 will be given later.

Next, operation of the server 10 and the terminal apparatus 20 will be described. First, operation of the terminal apparatus 20 will be described.

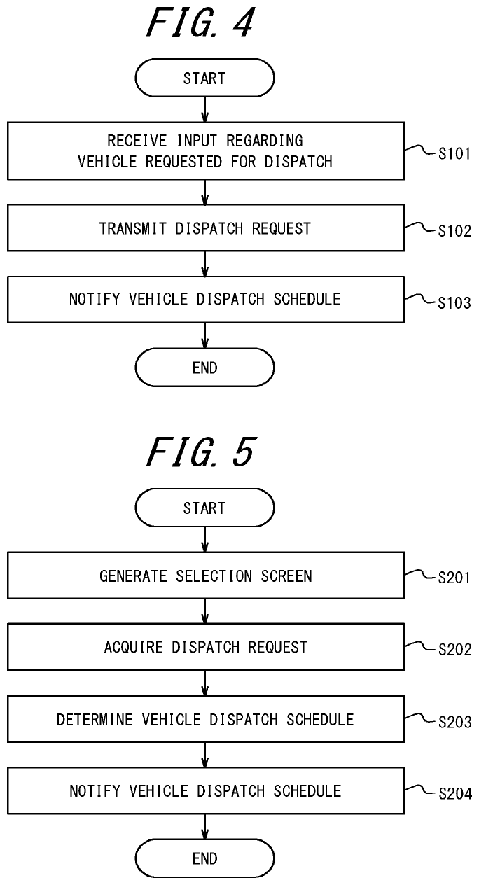

FIG. 4 is a flowchart illustrating example operation of the terminal apparatus 20.

The terminal apparatus 20 receives an input regarding the vehicle 2, dispatch of which is requested by the user (step S101). For example, input about the vehicle 2, dispatch of which is requested by the user, may be performed by starting an application that is installed in the terminal apparatus 20 to be used for requesting for dispatch of the vehicle 2 (hereinafter referred to as a “dispatch request application”). When the dispatch request application is started, the terminal apparatus 20 transmits, to the server 10, a display request for a selection screen that is used to select the vehicle 2, dispatch of which is to be requested. The terminal apparatus 20 displays the selection screen that is transmitted from the server 10 in response to transmission of the display request. The terminal apparatus 20 may receive input about the vehicle 2, dispatch of which is requested by the user, on the basis of input of the user by the selection screen. Additionally, for example, when the dispatch request application is first started, the user may be requested to input the expected use location information about the location where use of the vehicle 2 by the user is expected, and the expected use location information that is input may be transmitted to the server 10.

After receiving input about the vehicle 2, dispatch of which is requested by the user, the terminal apparatus 20 transmits, to the server 10 via the network 30, a dispatch request including at least information about the vehicle 2 (such as the name of the vehicle 2), dispatch of which is requested (step S102). The dispatch request may include current position information for the terminal apparatus 20. For example, the terminal apparatus 20 may acquire the position information using a global positioning system (GPS) signal. Furthermore, the dispatch request may include requested dispatch location information about a location to which the vehicle 2 is requested by the user to be dispatched (for example, a workplace or a location near home). For example, the location to which the user requests the vehicle 2 to be dispatched may be input via the selection screen.

Additionally, as described above, the dispatch request from the terminal apparatus 20 may be stored in another server different from the server 10. In such a case, the terminal apparatus 20 transmits, via the network 30, the dispatch request to the other server for storing the dispatch request.

Next, when the terminal apparatus 20 is notified of the vehicle dispatch schedule of the vehicle 2 by the server 10, the terminal apparatus 20 notifies the user of the vehicle dispatch schedule by displaying the same, for example (step S103). Additionally, only the vehicle dispatch schedule of the vehicle 2, dispatch of which is requested by the user, may be notified to the terminal apparatus 20, or the vehicle dispatch schedule of a vehicle 2 different from the vehicle 2, dispatch of which is requested by the user, may also be notified to the terminal apparatus 20. That is, in a case in which the vehicle dispatch schedule is determined with respect to dispatch of a vehicle 2, the vehicle dispatch schedule of the vehicle 2 may be notified to users other than the user who requested for dispatch of the vehicle 2.

FIG. 5 is a diagram for describing an information processing method of the server 10 according to the present embodiment, and is a flowchart illustrating example operation of the server 10.

When a display request for the selection screen to be used to select the vehicle 2, dispatch of which is to be requested, is received from the terminal apparatus 20 via the network 30 and the communication interface 11, the controller 13 generates the selection screen using the database stored in the memory 12 (step S201). For example, the controller 13 generates the selection screen including the name of the vehicle 2 included in the vehicle information in the database, the item names and the prices included in the menu information corresponding to the vehicle information, and the like. Then, the controller 13 transmits image data for the generated selection screen to the terminal apparatus 20 that is the transmission source of the display request for the selection screen, via the communication interface 11 and the network 30, and causes the selection screen to be displayed.

Next, the communication interface 11 acquires a dispatch request from the terminal apparatus 20 (step S202). For example, in a case in which the dispatch request is transmitted from the terminal apparatus 20 to the server 10, the communication interface 11 receives (acquires) the dispatch request that is transmitted from the terminal apparatus 20 via the network 30. Furthermore, in a case in which the dispatch request is stored in another server different from the server 10, the communication interface 11 accesses the server storing the dispatch request via the network 30, and acquires the dispatch request.

The controller 13 determines the vehicle dispatch schedule of the vehicle 2 according to the dispatch request acquired by the communication interface 11 (step S203). A method of determining the vehicle dispatch schedule will be described later in detail.

When the vehicle dispatch schedule of the vehicle 2 is determined, the controller 13 notifies the terminal apparatus 20 of the determined vehicle dispatch schedule via the communication interface 11 and the network 30 (step S204). Furthermore, the controller 13 may also notify the determined vehicle dispatch schedule to the contact included in the vehicle information for the vehicle 2 for which the vehicle dispatch schedule is determined. Moreover, in a case in which the vehicle 2 is capable of communication via the network 30, the controller 13 may transmit the determined vehicle dispatch schedule to the vehicle 2.

Next, a specific example of the method for determining the vehicle dispatch schedule by the controller 13 will be given.

The controller 13 identifies a dispatch location of the vehicle 2, dispatch of which is requested, according to the dispatch request acquired from the terminal apparatus 20. Then, the controller 13 determines the vehicle dispatch schedule for dispatching the vehicle 2 to the identified dispatch location.

As described above, the dispatch request from the terminal apparatus 20 may include position information for the terminal apparatus 20. For example, the controller 13 may identify a location indicated by the position information included in the dispatch request as the dispatch location, and may determine the vehicle dispatch schedule for dispatching the vehicle 2, dispatch of which is requested, to the dispatch location. That is, in a case in which the position information of the terminal apparatus 20 is included in the dispatch request, the controller 13 may determine the vehicle dispatch schedule for dispatching the vehicle 2 to the dispatch location according to the position information included in the acquired dispatch request. The vehicle dispatch schedule for dispatching the vehicle 2 to a location according to the position of the terminal apparatus 20 may thus be determined.

Furthermore, as described above, the dispatch request from the terminal apparatus 20 may include the requested dispatch location information regarding the location to which the vehicle 2 is requested by the user to be dispatched. For example, the controller 13 may identify, as the dispatch location, the location indicated by the requested dispatch location information included in the dispatch request, and determine the vehicle dispatch schedule for dispatching the vehicle 2, dispatch of which is requested, to the dispatch location. That is, in a case in which the requested dispatch location information is included in the dispatch request, the controller 13 may determine the vehicle dispatch schedule for dispatching the vehicle 2 to the dispatch location according to the requested dispatch location information included in the acquired dispatch request. The vehicle dispatch schedule for dispatching the vehicle 2 to a location to which the vehicle 2 is requested by the user to be dispatched may thus be determined.

Furthermore, as described above, the expected use location information regarding a location where use of the vehicle 2 by the user is expected may be stored in the memory 12 (database) of the server 10. For example, when a dispatch request is acquired from the terminal apparatus 20, the controller 13 may refer to the database in the memory 12, identify, as the dispatch location, the location indicated by the expected use location information that is registered for the user of the terminal apparatus 20, and determine the vehicle dispatch schedule for dispatching the vehicle 2, dispatch of which is requested, to the dispatch location. That is, the controller 13 may refer to the database in which the expected use location information about the location where use of the vehicle 2 by the user is expected is registered in advance, and determine the vehicle dispatch schedule for dispatching the vehicle 2 to the dispatch location according to the expected use location information that is registered for the user of the terminal apparatus 20 that outputted the dispatch request. The vehicle dispatch schedule for dispatching the vehicle 2 to a location where use of the vehicle 2 by the user is expected may thus be determined.

Furthermore, the controller 13 may determine the vehicle dispatch schedule for the vehicle 2 when a predetermined condition is satisfied by dispatch requests from a plurality of terminal apparatuses 20. For example, when a dispatch request requesting dispatch of a specific vehicle 2 to a specific dispatch location is acquired from at least a predetermined number of terminal apparatuses 20, the controller 13 determines the vehicle dispatch schedule for dispatching the vehicle 2, dispatch of which is requested by the dispatch requests, to the specific dispatch location. Accordingly, the vehicle dispatch schedule for dispatching a vehicle 2 to one location may be determined when dispatch of the vehicle 2 to the location is requested by a plurality of terminal apparatuses 20, for example, and food and drink may thereby be more efficiently served by the vehicle 2.

Here, the controller 13 may refer to operation time information stored in the memory 12, and determine the vehicle dispatch schedule in such a way that operation can be smoothly performed between the operation start time and the operation end time at an operation location registered for the vehicle 2, dispatch of which is requested by the dispatch requests. For example, the controller 13 may determine the vehicle dispatch schedule for dispatching the vehicle 2 to a dispatch location, in a case in which the dispatch location of the vehicle 2 is a location, registered in the memory 12, that the vehicle 2 can move to between the operation end time at an operation location of the vehicle 2 and the operation start time at the next operation location, and also, if an operation time of at least a predetermined length can be secured at the dispatch location.

Moreover, the controller 13 may select a plurality of vehicles 2 to be dispatched, according to the dispatch requests from a plurality of terminal apparatuses 20, and determine the vehicle dispatch schedule for dispatching the plurality of selected vehicles 2 to the same dispatch location. For example, the controller 13 may select a predetermined number of vehicles 2 in descending order of the number of dispatch requests, among vehicles 2 that are requested to be dispatched by a plurality of dispatch requests, and determine the vehicle dispatch schedule for dispatching the predetermined number of vehicles 2 to a dispatch location for which there is the greatest number of dispatch requests.

As described above, in the information processing system 1 according to the present embodiment, the terminal apparatus 20 transmits, in response to an input from a user, a dispatch request which includes at least information regarding the vehicle 2 in which food and drink can be prepared and served and dispatch of which is requested by the user. The server 10 acquires the dispatch request from the terminal apparatus 20, and determines the vehicle dispatch schedule of the vehicle 2 according to the acquired dispatch request.

According to such a configuration, the vehicle dispatch schedule for the vehicle 2, dispatch of which is requested by a user, is determined in response to an input to the terminal apparatus 20 regarding the vehicle 2, dispatch of which is requested by the user, and food and drink may thus be served by the vehicle 2 in which food and drink can be prepared and served, to a user at a location where the vehicle 2 does not normally operate. Accordingly, food and drink may be served by the vehicle 2 that is requested by a user, to a greater number of users.

The embodiment described above is given as a typical example, but those skilled in the art will readily recognize that many modifications and substitutions may be made within the spirit and scope of the present disclosure. Accordingly, the present disclosure should not be interpreted as being limited to the embodiment described above, and various alterations and modifications may be made without departing from the scope of the claims. For example, a plurality of the structural blocks illustrated in the configuration diagrams for the embodiment may be combined into one, or one structural block may be divided into several blocks.

Furthermore, for example, one or more general-purpose information processing apparatuses, such as a smartphone or a computer, may be caused to function as the server 10 according to the embodiment described above. Specifically, a program describing processing contents for implementing each function of the server 10 according to the embodiment is stored in a memory of the information processing apparatus, and a processor of the information processing apparatus reads out and executes the program. Accordingly, the disclosure of the present embodiment may also be implemented as a program that is executable by a processor, or as a non-transitory computer-readable recording medium recording such a program.

Furthermore, in addition to the examples given above, the network 30 according to the present embodiment may be one or a combination of an ad hoc network, a metropolitan area network (MAN), a cellular network, a wireless personal area network (WPAN), a public switched telephone network (PSTN), a terrestrial wireless network, an optical network, or another network. Structural elements of a wireless network include an access point (such as a Wi-Fi access point), a femtocell, and the like, for example. Moreover, a wireless communication appliance may be connected to a wireless network that uses Wi-Fi® (Wi-Fi is a registered trademark in Japan, other countries, or both), Bluetooth® (Bluetooth is a registered trademark in Japan, other countries, or both), a cellular communication technology, or other wireless technologies and technology standards.

As described above, various aspects of the present disclosure may be embodied in various different modes, all of which are included in the scope of the present embodiment.

1. A server capable of communicating with at least one terminal apparatus that is used by a user, the server comprising:
an acquisition interface for acquiring a dispatch request from the terminal apparatus, the dispatch request including at least information regarding a vehicle in which food and drink can be prepared and served, and dispatch of which is requested by the user; and
a controller for determining a vehicle dispatch schedule for the vehicle according to the dispatch request acquired by the acquisition interface.

2. The server according to claim 1, wherein
the dispatch request includes position information for the terminal apparatus, and
the controller determines the vehicle dispatch schedule for dispatching the vehicle to a dispatch location according to the position information.

3. The server according to claim 1, wherein
the dispatch request includes requested dispatch location information regarding a location to which the vehicle requested by the user is to be dispatched, and
the controller determines the vehicle dispatch schedule for dispatching the vehicle to a dispatch location according to the requested dispatch location information.

4. The server according to claim 1, wherein the controller refers to a database in which expected use location information is registered in advance, the expected use location information regarding a location where use of the vehicle by the user is expected, and determines the vehicle dispatch schedule for dispatching the vehicle to a dispatch location according to the expected use location information that is registered for the user of the terminal apparatus which outputs the dispatch request.

5. The server according to claim 1, wherein the controller determines the vehicle dispatch schedule for the vehicle, when a predetermined condition is satisfied by dispatch requests from a plurality of terminal apparatuses.

6. The server according to claim 1, wherein the controller selects a plurality of vehicles in response to dispatch requests from a plurality of terminal apparatuses, and determines the vehicle dispatch schedule for dispatching the plurality of vehicles selected to a same dispatch location.

7. The server according to claim 1, wherein the controller notifies the terminal apparatus of the vehicle dispatch schedule of the vehicle that is determined.

8. An information processing system comprising:
at least one terminal apparatus that is used by a user; and
a server that is capable of communicating with the terminal apparatus, wherein
the terminal apparatus transmits, in response to an input from the user, a dispatch request which includes at least information about a vehicle in which food and drink can be prepared and served, and dispatch of which is requested by the user, and
the server
acquires the dispatch request from the terminal apparatus, and
determines a vehicle dispatch schedule for the vehicle according to the dispatch request that is acquired.

9. The information processing system according to claim 8, further comprising a vehicle including an autonomous driving function, wherein
the vehicle receives the vehicle dispatch schedule, and performs autonomous driving according to the vehicle dispatch schedule.

10. An information processing method for a server that is capable of communicating with at least one terminal apparatus that is used by a user, the method comprising:
acquiring a dispatch request from the terminal apparatus, the dispatch request including at least information regarding a vehicle in which food and drink can be prepared and served, and dispatch of which is requested by the user; and
determining a vehicle dispatch schedule for the vehicle according to the dispatch request that is acquired.
